(19) United States
(12) Patent Application Publication
(10) Pub. No.: US 2004/0188030 A1
(43) Pub. Date: Sep. 30, 2004

(54) Light and portable adhesive tape cutter

(76) Inventor: Yu-Gang Chen, Tainan County (TW)

Correspondence Address: Far East College, P.O. Box No. 6-57, Junghe, Taipei, 235, TW

(21) Appl. No.: 10/801,665

(22) Filed: Mar. 17, 2004

(30) Foreign Application Priority Data
Mar. 25, 2003 (TW) 092204568

(51) Int. Cl. B32B 31/00

(52) U.S. Cl. 156/510; 156/523

(57) ABSTRACT

A light and portable adhesive tape cutter according to the invention includes a gathering section having elasticity. Two ends of the gathering section are respectively devised with a fixed cutter seat and a sliding cutter seat each having a sawtooth. The gathering section is appropriately wrapped by an adhesive tape roll. The sliding cutter seat is capable of sliding movements to become mounted on the fixed cutter seat to altogether cut off the adhesive tape in a quick and convenient manner. The adhesive tape cutter may also be a simplified cutter seat as a formed integral that can be rapidly wrapped by an adhesive tape roll for quickly cutting off an adhesive tape.

### BACKGROUND OF THE INVENTION

(a) Field of the Invention

The invention relates to a light and portable adhesive tape cutter, and more particularly, to a light and portable adhesive tape cutter having a gathering section for appropriately wrapping around an adhesive tape roll. Using a sliding groove at a sliding cutter seat of the invention, a position of a locating element of a fixed cutter seat is adjusted as desired, thereby adapting to adhesive tape rolls having different widths to cut off the adhesive tapes. In addition, the cutter seat according to the invention may be devised as a simplified cutter seat of a formed integral having convenient and practical effects as well as minimal production costs.

(b) Description of the Prior Art

A current adhesive tape roll is frequently installed on a cutter for quickly cutting the adhesive tape. However, the cutter has a large volume that occupies a large space, and is thus awkward with respect to portability thereof. A simplified cutter disclosed by Taiwan Patent Publication 405598 has later become available. This prior invention comprises a U-shaped main frame; corresponding embedding edges at two lower inner sides of the main frame to fasten into an inner portion of an adhesive tape and form a compact usage status; a through groove at a rear portion of the main frame, with a width of the through groove exactly leveling with a tip of the adhesive tape; an attaching protruding section formed by a rhombus having four inclined surfaces at a front portion of the through groove to provide dual effects of adhesion and detaching a tip of an adhesive tape; and a cutting blade appears as a transverse sawtooth at a front edge of the main frame to more quickly and effortlessly cutting off an adhesive tape. Although this prior cutter provides usage conveniences, widths thereof are remained unchanged without capabilities of adapting to adhesive tape rolls having different widths. To be more exact, cutters of different dimensions are necessarily produced for applications of adhesive tape rolls having different widths. Thus, production costs hardly account as economical and maximum practicability are left unmet.

### SUMMARY OF THE INVENTION

The primary object of the invention is to provide a light and portable adhesive tape cutter suitable for adhesive tapes having different widths, capable of quickly cutting off adhesive tapes, and having a small volume that occupies minimal spaces.

The other object of the invention is to provide a light and portable adhesive tape cutter having simple manufacturing processes, low production costs and enhanced practical values.

An adhesive tape cutter according to the invention comprises a gathering section, which has a fixed cutter seat and a sliding cutter seat at two ends thereof. The fixed cutter seat and the sliding cutter seat are provided with sawteeth as same side edges thereof, such that the sliding cutter seat can be overlapped with the fixed cutter seat through sliding movements thereof.

The adhesive tape cutter according to the invention may also be devised as a simplified cutter seat from a formed integral made of a plastic material and having elasticity. The simplified cutter seat has a bent gathering section at a lower portion thereof and a sawtooth at a top portion thereof.

### BRIEF DESCRIPTION OF THE DRAWINGS

FIG. 1 shows an exploded elevational view according to the invention.

FIG. 2 shows an elevational view according to the invention.

FIG. 3 shows a schematic view according to the invention in use.

FIG. 4 shows a schematic view illustrating the invention being used for cutting an adhesive tape.

FIG. 5 shows a schematic view illustrating the invention using adhesive tape rolls having different widths.

FIG. 6 shows a schematic view of another embodiment according to the invention.

FIG. 7 shows a schematic view of yet another embodiment according to the invention.

FIG. 8 shows a structural schematic view of a simplified cutter seat according to the invention.

FIG. 9 shows a first schematic view of a simplified cutter seat in an embodiment according to the invention.

FIG. 10 shows a second schematic view of a simplified cutter seat in an embodiment according to the invention.

FIG. 11 shows a view a simplified cutter seat in another embodiment according to the invention.

FIG. 12 shows a view a simplified cutter seat in yet another embodiment according to the invention.

### DETAILED DESCRIPTION OF THE PREFERRED EMBODIMENTS

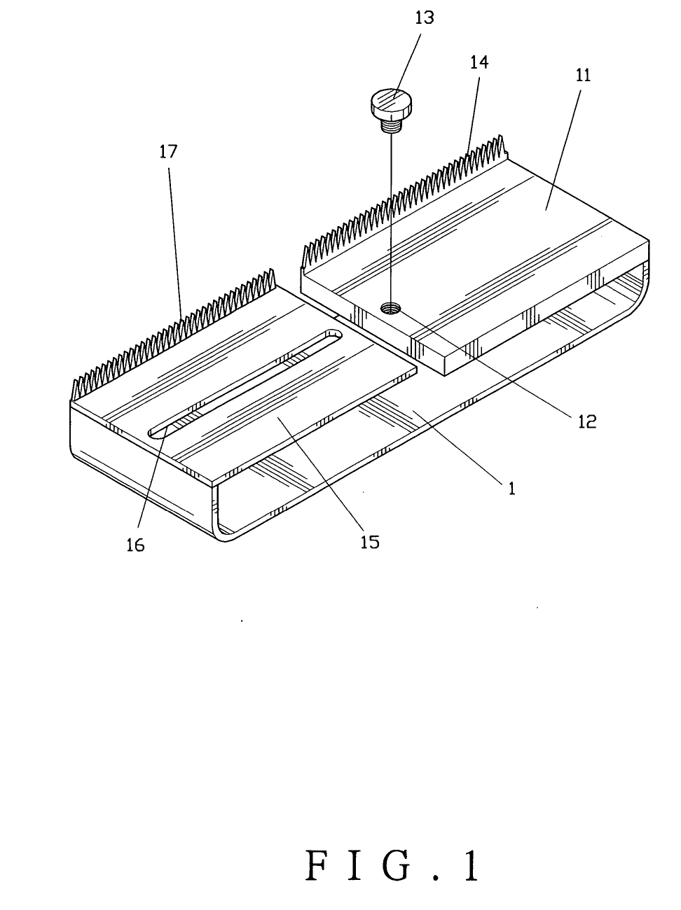

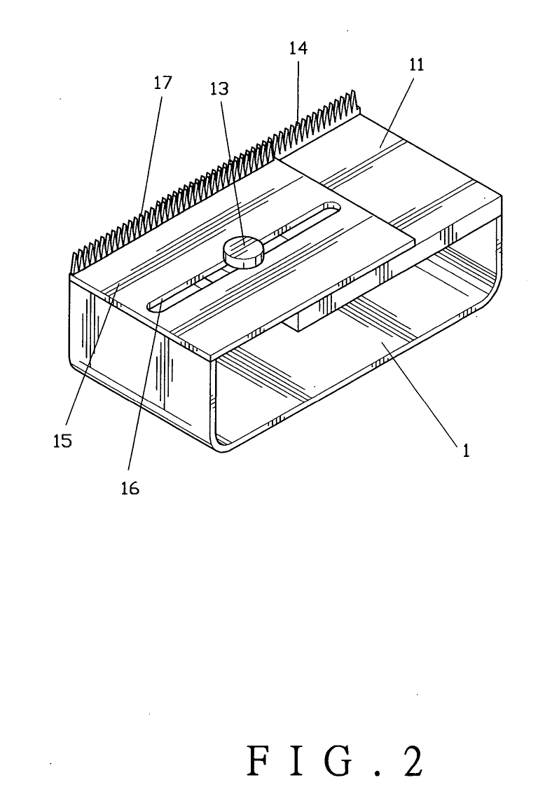

Referring to FIGS. 1 and 2, a light and portable adhesive tape cutter comprises a gathering section 1. The gather section 1 is made of a flexible strip body, and has a fixed cutter seat 11 at one end thereof. The fixed cutter seat 11 has a screw opening 12 for installing a locating element 13. The cutter seat 11 also has a sawtooth 14 at a side edge thereof. A sliding cutter seat 15 is located at the other end of the gathering section 1 and has a sawtooth 17 at a side corresponding to the sawtooth 14 of the fixed cutter seat 11. The sawtooth 17 has a height smaller than that of the sawtooth 14, such that heights of the sawtooth 14 and the sawtooth 17 are leveled with each other when the sliding cutter seat 15 is mounted on the fixed cutter seat 11.

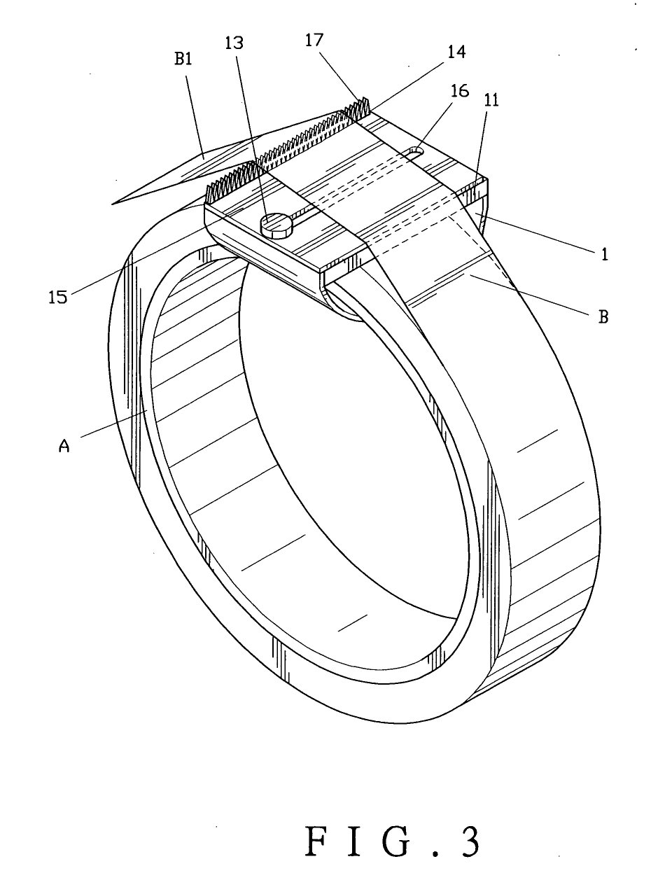

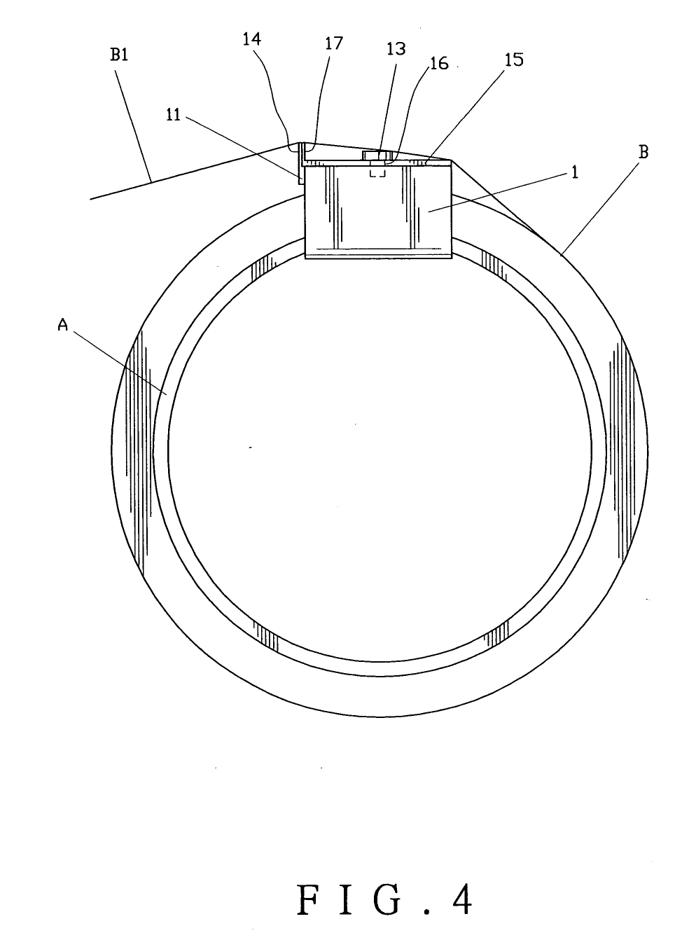

To put the invention to use, referring to FIG. 3, the fixed cutter seat 11 and the sliding cutter seat 17 at the two ends of the gathering section 1 are respectively wrapped by a tip of an adhesive tape A. The sliding cutter seat 15 is overlapped with the fixed cutter seat 11 to have a sliding groove 16 of the sliding cutter seat 15 locate on the screw opening 12. The screw opening 12 is fastened with the fastening element 13 therein, and a position of the sliding groove 16 at the fastening element 13 is adjusted, so as to have the gathering section 1 appropriately wrapped by the adhesive tape A. The fastening element 13 is turned and tightened to lock the fixed cutter seat 11 and the sliding cutter seat 15. An adhesive tape B is pulled with an appropriate length, and then pressed downward again as shown in FIG. 4. Thus, a pulled out section B1 of the adhesive tape B is cut off by the sawteeth 14 and 17 in a quick and convenient manner.

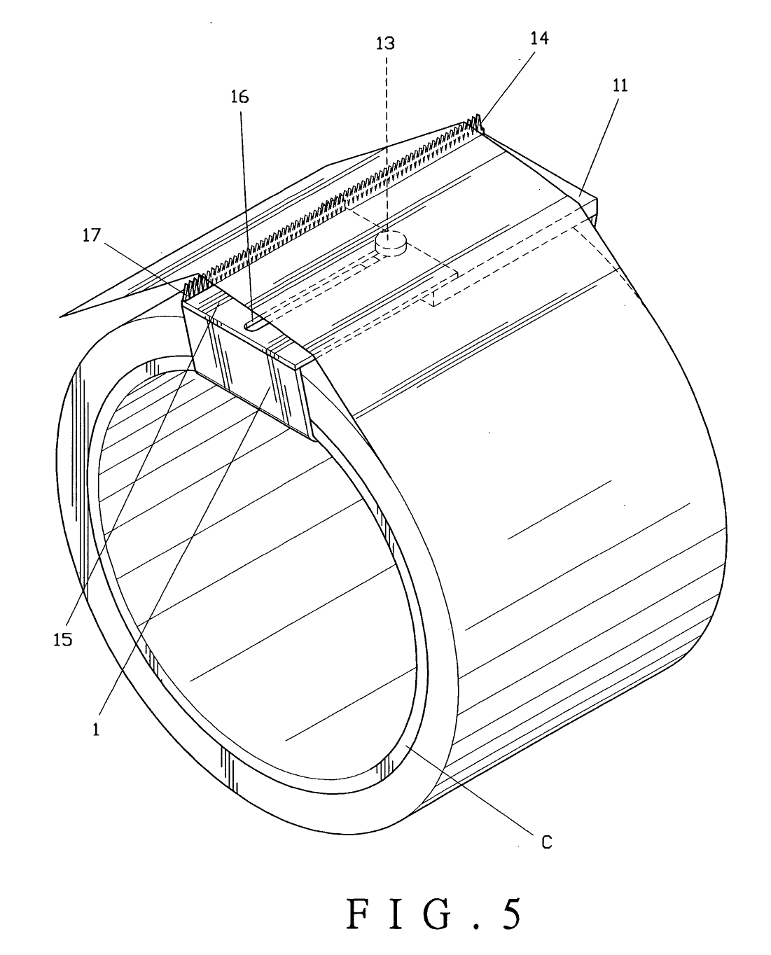

Referring to FIG. 5 showing adhesive tape C having a different width, the fastening element 13 is similarly loosened to have the fixed cutter seat 11 and the sliding cutter seat 15 at the two ends of the gathering section 1 wrapped by the adhesive tape C, and the sliding cutter seat 15 is then overlapped with the fixed cutter blade 11. A position of the sliding groove 16 at the fastening element 13 is adjusted to allow the gathering section 1 appropriately wrapped by the adhesive tape C. The fastening element 13 is turned and tightened to lock the fixed cutter seat 11 and the sliding cutter seat 15, thereby accommodating usage of the adhesive tape C having a different width.

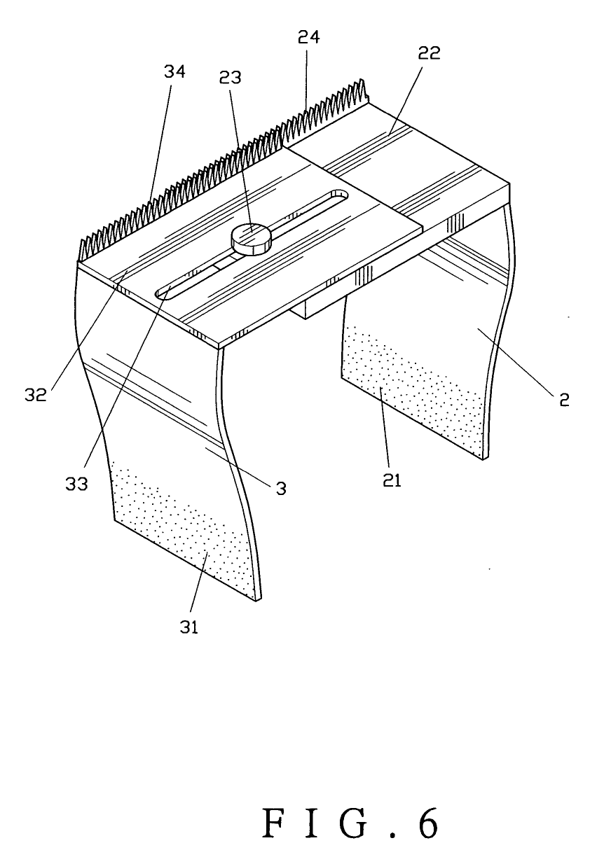

Referring to FIG. 6, another embodiment according to the invention comprises two gathering sections 2 and 3. The two gathering sections 2 and 3 have one ends thereof disposed with attaching strips 21 and 31, respectively, and the other ends thereof provided with a fixed cutter seat 22 and a sliding cutter seat 32. Wherein, the fixed cutter seat 22 is screwed with a locating element 23, and the sliding cutter seat 32 is provided with a sliding groove 33. The fixed cutter seat 22 and the sliding cutter seat 32 also have sawteeth 24 and 34 at same side edges thereof. By mounting the sliding cutter seat 32 on the fixed cutter seat 22, the sliding groove 33 of the sliding cutter seat 32 is moved at the locating element 23 of the fixed cutter seat 22 to adjust to an appropriate position. The attaching strips 21 and 32 are joined to become one body, and are then appropriately wrapped around the adhesive tape using the two gathering sections 2 and 3, thereby cutting off the adhesive tape in a quick and convenient manner.

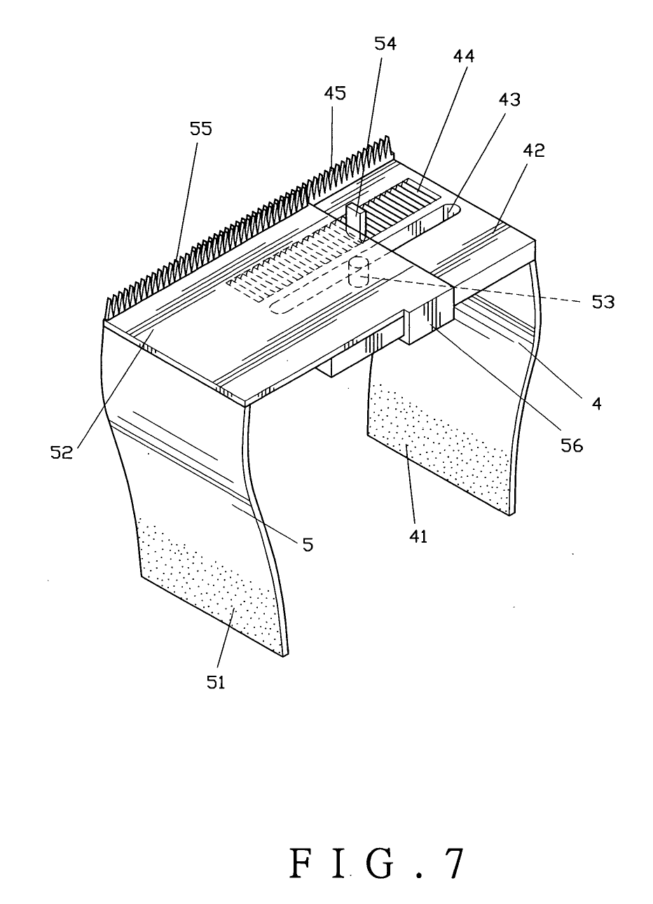

Referring to FIG. 7, another embodiment according to the invention comprises two gathering sections 4 and 5. The two gathering sections 4 and 5 have one ends thereof disposed with attaching strips 41 and 51, respectively, and the other ends thereof provided with a fixed cutter seat 42 and a sliding cutter seat 52. Wherein, the fixed cutter seat 42 is provided with a locating element 43 having a row of tooth members 44 at a side thereof, and a sawtooth 45 at an edge thereof. The sliding cutter seat 52 is provided with a downwardly extended locating column 53 capable of sliding movements within the sliding groove 43. The sliding cutter seat 52 further has a locating block 54 that can be moved upward and downward at an end surface thereof, a sawtooth 55 at an edge thereof, and a locating clamp 56 at a lower portion thereof. Thus, when the sliding cutter seat 52 is mounted on the fixed cutter seat 42, the locating column 53 of the sliding cutter seat 52 is moved within the sliding groove 43 of the fixed cutter seat 42 to situate at an appropriate position. By moving and locating the locating block 54 at the tooth members 44, the sliding cutter seat 52 is firmly positioned with the fixed cutter seat 42, and is prevented from undesired sliding movements when in use. The attaching strips 41 and 51 are joined to become one body, and are then appropriately wrapped around the adhesive tape using the two gathering sections 4 and 5, thereby cutting off the adhesive tape in a quick and convenient manner.

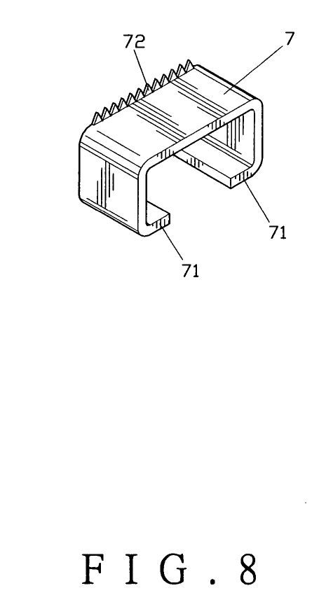

Apart from the aforesaid embodiments, the invention may also be devised as a simplified cutter seat using a formed integral. Referring to FIG. 8, a cutter seat 7 as a formed integral according to the invention is made of a plastic material having a certain degree of elasticity. The cutter seat 7 comprises two gathering sections 71 at a lower portion thereof, and a row of sawtooth 72 at an upper edge of one of end surfaces thereof.

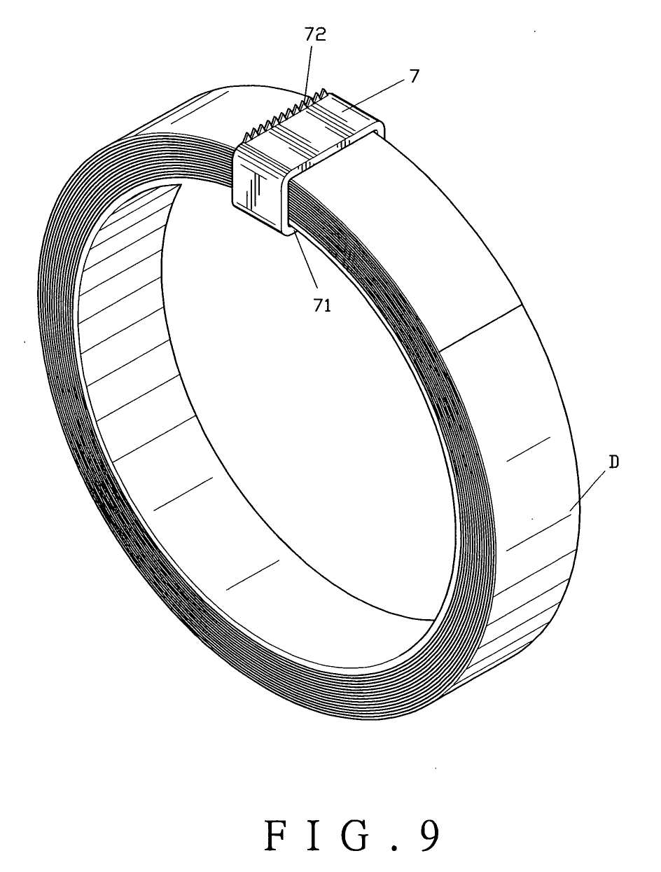

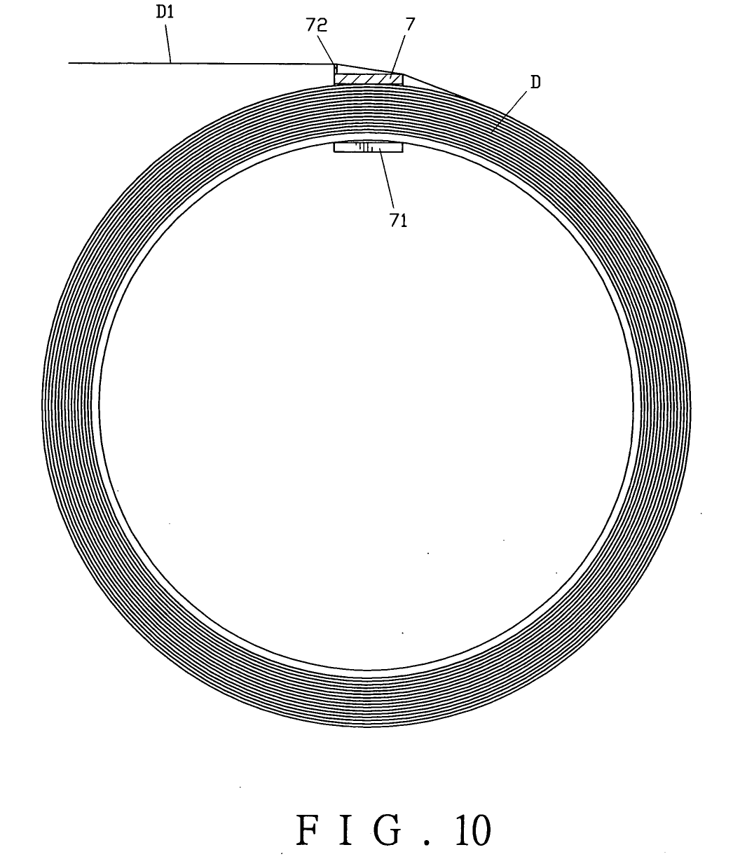

To put the invention to use, referring to FIGS. 9 and 10, the gathering sections 71 at the two ends of the cutter seat 7 are respectively wrapped at two ends of an adhesive tape roll D, and are then flexibly accommodated around the adhesive tape D using elasticity of the cutter seat 7. To cut off the adhesive tape, the cutter seat 7 is moved at the adhesive tape D, and the end surface of the cutter seat 7 having the sawtooth 72 is pressed against an appropriate position of a pull-out section D1 of the adhesive tape roll D. The pull-out section D1 is pressed downward to cut off the adhesive tape using the sawtooth 12 in a quick and convenient manner.

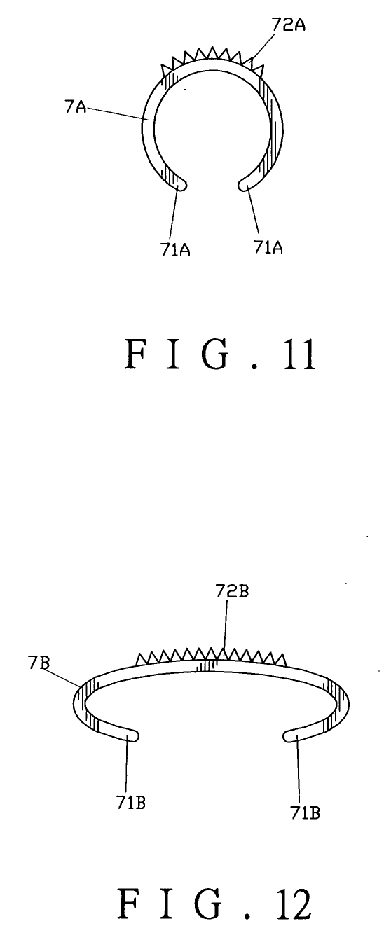

Referring to FIGS. 11 and 12 showing another embodiment according to the invention, cutter seats 7A and 7B are devised into different shapes. For example, the cutter seat 7A is round in shape and the cutter seat 7B is oval in shape; or, cutter seats having other sectional shapes may also be adopted. The cutter seats 7A and 7B are each provided with a gathering section 71 at a lower end portion thereof, and sawteeth 72A and 72B at upper portion thereof, thereby similarly having handy installing processes as well as being capable of cutting off adhesive tapes in a quick and convenient manner.

Conclusive from the aforesaid descriptions, the invention has the following excellences:

1. The gathering section according to the invention has a fixed cutter seat and a flexible cutter seat at two ends thereof. Using the sliding groove of the flexible cutter seat, a position of the fastening element of the fixed cutter seat can be adjusted for adapting to adhesive tapes having different widths.

2. Assembly processes of the invention are kept simple for quickly installing and replacing various adhesive tapes, while also having a small volume for good portability.

3. A simplified cutter seat according to the invention is a formed integral made of a plastic material. Thus, the simplified cutter seat is provided with elasticity for quickly accommodating around an adhesive tape and facilitating cutting off the adhesive tape.

4. The simplified cutter seat has a simple structure, which can be manufactured with minimal production costs and has a small volume for good portability.

It is of course to be understood that the embodiments described herein are merely illustrative of the principles of the invention and that a wide variety of modifications thereto may be effected by persons skilled in the art without departing from the spirit and scope of the invention as set forth in the following claims.

What is claimed is:

1. A light and portable adhesive tape cutter comprising a gathering section having a fixed cutter seat and a sliding cutter seat at two ends thereof, wherein the fixed cutter seat and the sliding cutter seat are provided with sawteeth at edges of a same side thereof, such that the sliding cutter seat is capable of sliding movements to become mounted on the fixed cutter seat.

2. The light and portable adhesive tape cutter in accordance with claim 1, wherein the gathering section is a formed integral strip having elasticity.

3. The light and portable adhesive tape cutter in accordance with claim 1, comprising two gathering sections each having one end thereof provided with an attaching strip for joining with each other to form one body.

4. The light and portable adhesive tape cutter in accordance with claim 1, comprising two gathering sections each having one end thereof provided with an attaching strip, and the other end thereof devised with a fixed cutter seat and a sliding cutter seat; wherein, the fixed cutter seat and the sliding cutter seat have sawteeth at side edges thereof; the fixed cutter seat has a sliding groove further having a row of tooth members at a side thereof; and the sliding cutter seat has a downwardly extended column, a locating block that can be moved upward and downward at an end surface thereof, a sawtooth at a side edge thereof, and a locating clamp at a lower portion thereof.

5. A light and portable adhesive tape cutter being a simple cutter seat as a formed integral made of a plastic material with elasticity; and having a bent gathering section at a lower portion thereof, and a sawtooth at an upper edge thereof.
